(19) United States
(12) Patent Application Publication
(10) Pub. No.: US 2026/0128616 A1
(43) Pub. Date: May 7, 2026

(54) Systems and Methods for Fully Wireless and Batteryless Localization and Physiological Motion Detection

(71) Applicant: The Regents of the University of California, Oakland, CA (US)

(72) Inventors: Aydin Babakhani, Los Angeles, CA (US); Arkaprova Ray, Los Angeles, CA (US); Iman Habibagahi, Los Angeles, CA (US)

(73) Assignee: The Regents of the University of California, Oakland, CA (US)

(21) Appl. No.: 19/114,408

(22) PCT Filed: Sep. 22, 2023
(86) PCT No.: PCT/US2023/074927

§ 371 Date: Mar. 21, 2025

Related U.S. Application Data
(60) Provisional application No. 63/376,717, filed on Sep. 22, 2022.

(51) Int. Cl. H02J 50/20; H02J 50/80; H02J 50/90; H02J 105/46; H02M 1/14

(52) U.S. Cl. CPC H02J 50/20; H02J 50/80; H02J 50/90; H02M 1/143; H02J 2105/46

(57) ABSTRACT

A battery-less, wirelessly powered localization system is described. In an embodiment, a wirelessly powered localization system, includes an external Tx antenna that generates a radio frequency (RF) signal that wirelessly powers a set of one or more localizers, an external Rx antenna that receives an output from the localizers, a localizer including: an Rx antenna that receives a radio frequency (RF) signal from an external Tx antenna, a passive four-stage full-wave CMOS rectifier that generates a DC voltage using the received RF signal, a low-dropout regulator that generates a stable DC voltage based on the rectifier-generated voltage, a frequency divider circuit to divide the frequency of received RF signal, and a Tx antenna that outputs an RF signal at the divided frequency to the external Rx antenna.

### CROSS-REFERENCE TO RELATED APPLICATIONS

The current application claims the benefit of and priority under 35 U.S.C. § 119(e) to U.S. Provisional Patent Application No. 63/376,717 entitled “Systems and Methods for Fully Wireless and Batteryless Localization and Physiological Motion Detection” filed Sep. 22, 2022, the disclosure of which is hereby incorporated by reference in its entirety for all purposes.

### FIELD OF THE INVENTION

The present invention generally relates to integrated circuits and, more specifically, localizer integrated circuits wirelessly powered by radio frequency signals.

### BACKGROUND OF THE INVENTION

Gastrointestinal (GI) tract diseases are illnesses linked to the digestive system. GI tract refers to the organs that food and liquid travel when they are ingested, including the mouth, throat, esophagus, stomach, small and large intestines, rectum, and anus. Between 60 and 70 million people are affected by GI tract diseases each year, and some people are afflicted with chronic conditions that are difficult to treat.

Wireless power transmission refers to the transmission of electrical energy without wires as a physical connection. There are two main categories of wireless power techniques: near field and far field. An example of near near-field wireless power technique is inductive coupling, where power is transferred over a short distance through coils of wire or electric fields using capacitive coupling between metal electrodes.

Radio frequency integrated circuits (RFIC) have applications in radar and wireless communications. Wireless transceivers may be integrated into RFICs, and this allows for system-on-a-chip solutions as compared to system-on-package solutions. Highly integrated RF components are replacing circuits that use discrete semiconductor devices due to their enhanced performance. RFICs are becoming cost-effective solutions that provide reliability and reproducibility.

### SUMMARY OF INVENTION

Systems and methods for wirelessly powered stimulators in accordance with embodiments of the invention are disclosed. In one embodiment, a battery-less, wirelessly powered localization system includes an external transmit (Tx) antenna configured to generate a radio frequency (RF) power transfer signal that wirelessly powers at least one localizer, an external receive (Rx) antenna configured to receive an RF localization signal transmitted from the at least one localizers, and the at least one localizer including: an Rx antenna configured to receive the RF power transfer signal from an external Tx antenna, a rectifier configured to generate a DC voltage using the received RF signal, a low-dropout regulator (LDO) configured to generate a stable DC voltage based on the DC voltage generated by the rectifier, a frequency divider circuit configured to divide the frequency of received RF signal, and a Tx antenna configured to output the RF localization signal at the divided frequency to the external Rx antenna.

In another embodiment, the localizer is fabricated on a printed circuit board (PCB).

In a further embodiment, the rectifier is a passive four-stage full-wave CMOS rectifier.

In still another embodiment, the rectifier has a cross-coupled topology.

In a still further embodiment, the rectifier further comprises a plurality of deep n-well transistors.

In yet another embodiment, each stage of the rectifier further comprises coupling capacitors coupled to the signal to the input of the rectifier.

In a yet further embodiment, the localizer further comprises an on-chip storage capacitor configured to reduce the ripple at the output of the rectifier.

In another additional embodiment, the LDO further comprises a smoothing capacitor.

In a further additional embodiment, the LDO further comprises a compensation capacitor of a capacitance that is dependent upon the capacitance of the smoothing capacitor.

In another embodiment again, the frequency divider circuit is a divide-by-3 circuit.

In a further embodiment again, the divide-by-3 circuit further comprises a mod-3 counter and an additional flip-flop.

In still yet another embodiment, the RF power transfer signal has a frequency of 40.68 Mhz, and the RF localization signal has a frequency of 13.56 Mhz.

In a still yet further embodiment, further including a controller including: a memory, and a processor configured by the memory to determine the position of the localizer by identifying a maximum localization signal power.

In still another additional embodiment, the power of the RF localization signal is used to power a sensor electrically coupled to the localizer.

In a still further additional embodiment, the RF localization signal is modulated to encode data from a sensor decodable by the controller.

In still another embodiment again, the phase of the RF localization signal is synchronized to the phase of the RF power transfer signal.

In a still further embodiment again, the phase of the RF localization signal is used to determine the position of the localizer.

In yet another additional embodiment, the amplitude of the RF localization signal is used to determine the position of the localizer.

One embodiment includes a method for monitoring localization and physiological movements using a wirelessly powered localizer, where the method includes transmitting an RF power transfer signal using a Tx antenna of a controller, receiving the RF power transfer signal at an Rx coil of a localizer, rectifying the received RF power transfer signal to generate a DC voltage, generating a stable DC voltage based on the generated DC voltage, dividing the received RF signal to generate an RF localization signal, transmitting the RF localization signal to an Rx antenna of a controller, receiving the RF localization signal at the Rx antenna of the controller, and determining the location of the localizer.

One embodiment includes a wirelessly powered localizer, including an Rx antenna configured to receive the RF power transfer signal from an external Tx antenna, a rectifier configured to generate a DC voltage using the received RF signal, a low-dropout regulator (LDO) configured to generate a stable DC voltage based on the DC voltage generated by the rectifier, a frequency divider circuit configured to divide the frequency of received RF signal, and a Tx antenna configured to output the RF localization signal at the divided frequency to the external Rx antenna.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an ex vivo verification process in which two localizers are swallowed and provide location information in accordance with an embodiment of the invention.

FIG. 2 illustrates a system architecture of a localizer in accordance with an embodiment of the invention.

FIGS. 3A-B illustrate circuit models for the wireless power transfer (WPT) link between the transmission (Tx) coil and localizer coil 1, and localizer coil 2 and the receive (Rx) coil in accordance with an embodiment of the invention.

FIG. 4 illustrates the details of coil design parameters in accordance with an embodiment of the invention.

FIG. 5A illustrates the coupling factors for a localizer coil diameter of 8 mm as the diameter of the Tx coil and distance between the Tx coil and localizer are varied in accordance with embodiments of the invention.

FIG. 5B illustrates the calculated link efficiency versus coupling factor in accordance with an embodiment of the invention.

FIG. 6 illustrates a circuit schematic of rectifiers in accordance with an embodiment of the invention.

FIGS. 7A-B illustrate the power conversion efficiency (PCE) and bandwidth of the rectifier for different NMOS transistor widths and input powers in accordance with embodiments of the invention.

FIG. 8 illustrates a circuit schematic of the low dropout regulator (LDO) in accordance with an embodiment of the invention.

FIGS. 9A-B illustrate the simulated magnitude and phase of the loop gain of the LDO under zero and 10 μA load current conditions in accordance with embodiments of the invention.

FIG. 10A illustrates the simulated power supply rejection ratio (PSRR) of the LDO in accordance with an embodiment of the invention.

FIG. 10B illustrates the power spectral density (PSD) of the noise at the LDO output in accordance with an embodiment of the invention.

FIG. 11 illustrates the specifications of the LDO in accordance with an embodiment of the invention.

FIG. 12 illustrates a circuit schematic of a divide-by-3 circuit in accordance with an embodiment of the invention.

FIG. 13A illustrates the power at the output of a buffer following the divide-by-3 circuit with respect to the input power of the rectifier when the buffer is loaded with the circuit parameters of localizer coil 2 in accordance with an embodiment of the invention.

FIG. 13B illustrates the output resistance of the buffer with respect to the input power of the rectifier in accordance with an embodiment of the invention.

FIG. 14 illustrates a process for operating a battery-less, wirelessly powered localization system in accordance with an embodiment of the invention.

FIGS. 15A-C illustrate the fabricated localizer, and the Tx and Rx antennas in accordance with an embodiment of the invention.

FIG. 16 illustrates a microscopic image of a fabricated localizer without two 8 mm coils in accordance with an embodiment of the invention.

FIG. 17A illustrates the rectifier and LDO output voltages with respect to input root-mean-square (RMS) voltage in accordance with an embodiment of the invention.

FIG. 17B illustrates the breakdown of the power consumption of the IC in accordance with an embodiment of the invention.

FIGS. 18A-B illustrate a verification process evaluating the effectiveness of the localization system in accordance with an embodiment of the invention.

FIGS. 19A-B illustrate a measurement setup used for ex vivo verification of the localization system using porcine intestine in accordance with an embodiment of the invention.

FIG. 20 illustrates a measurement setup verifying the functionality of sensing the rate of physiological motion in accordance with an embodiment of the invention.

FIGS. 21A-B illustrate the received spectrogram for the motion rates of 10 and 5 beats per minute respectively.

FIGS. 22A-B illustrate the signal power magnitudes obtained from the magnitude of the received spectrogram when the localizer is placed in air and phosphate buffered saline (PBS) solution respectively.

FIGS. 22C-D illustrate the extracted motion rates from the received signal power when the localizer is placed in air and PBS solution respectively.

FIGS. 23A-B illustrate the frequency noises obtained from the phase of the received spectrogram when the localizer is placed in air and PBS solution respectively.

FIGS. 23C-D illustrate the extracted motion rates from the frequency noise of the received signal when the localizer is placed in air and PBS solution respectively.

FIG. 24 illustrates a measurement setup used to sense the distance moved by the localizer in accordance with an embodiment of the invention.

FIG. 25 illustrates the spectrum of the signal at the input of the power detector in accordance with an embodiment of the invention.

FIGS. 26A-E illustrate the oscilloscope waveforms obtained when the localizers are moved by a distance of 50, 100, 200, 500, and 1000 μm respectively.

FIG. 26F illustrates the peak-to-peak voltage obtained at the oscilloscope with respect to the distance moved in accordance with an embodiment of the invention.

FIGS. 27 A-C illustrate the oscilloscope waveforms obtained when the oscilloscope input is connected to the modulation input of the RF source, and the localizers are moved by a distance of 200, 500, and 1000 μm respectively.

FIG. 27D illustrates the peak-to-peak voltage obtained at the oscilloscope with respect to the distance moved in accordance with an embodiment of the invention.

### DETAILED DESCRIPTION OF THE DRAWINGS

Small form-factor, wireless sensors in recent years have been deployed for enhancing healthcare delivery, patient monitoring, and disease management. When deciding how to power wireless sensors, there are currently two primary options: wireless power transfer, and battery power. While batteries can provide stable operation for a known period of time, they can also suffer from drawbacks such as limited lifetime and possible chemical leakages. These limitations may prevent the usage of battery-powered sensors in wearable and/or implantable biomedical applications, which makes wirelessly-powered sensors the increasingly popular choice for use in biomedical applications.

For example, gastrointestinal (GI) tract diseases are among one of the most widespread diseases in the world. Accurate diagnosis and effective treatment of GI tract diseases often involve insertion of endoscopes, which can be painful and inconvenient. In contrast, a wireless capsule endoscope (WCE) is a wireless sensor packaged in a swallowable capsule which can provide similar clinical data as to a conventional endoscope with significantly less discomfort. The emergence of WCEs has proven to be an important advancement as patients can do away with the conventional endoscopes which are often uncomfortable and sometimes require sedation. WCEs only require the patient to swallow a WCE, which can wirelessly transmit data back to the medical professional. WCEs, therefore, provide an alternative, painless procedure for monitoring the GI tract.

Once a WCE (or any other sensor) is deployed in a human body, it can be difficult without the assistance of ongoing imaging to determine where exactly the device is. Localization is a process of determining the position of a device, and localization of wireless sensors is particularly significant in medical applications where accurate and precise data collection is essential for monitoring the vital signs of patients to facilitate timely intervention, disease diagnosis, and treatment.

Localization processes in the medical field currently require power. Current localization systems for biomedical applications have largely relied on two significant approaches: magnetic localization and electromagnetic (EM) wave-based localization. While magnetic localization enjoys lesser signal attenuation when used in animal and human bodies, magnetic localization techniques suffer from interference created by magnetic fields from various sources around the device, hence resulting in inaccurate measurements. When it comes to EM localization, radio frequency (RF) has most commonly been used. RF-based localization typically involves using devices of a smaller form factor thereby leading to reduced costs. However, RF signals may be attenuated by different amounts at different locations inside an animal or human body. Therefore, proper characterization of the medium and a good choice of frequency are required before localization.

In RF-based localization, the requirements for penetration of RF signals through animal tissue, skin, and bones limit their frequencies to less than a few hundred megahertz (MHz). Reducing the form factor of the localization system may require the design of millimeter-scale coils or antennas. At such frequencies, the constraints on antenna size can reduce the efficiency of the wireless link. This can lead to either using higher transmission (Tx) power or designing integrated circuits (ICs) having lower power consumption. The accuracy of RF-based localization can also directly depend on the signal-to-noise ratio (SNR) at the receiver. A larger received signal power can therefore lead to an improved SNR. At MHz-range frequencies, the Tx and reception (Rx) antennas are almost always in the near field. Attempts to increase the operating range of the link can lead to increased path loss

$$( ∝ \frac{1}{{r}^{6}} ) ,$$

and, consequently, less received power. Conventional RF-based localization systems utilize power-hungry oscillators and phase locked loops (PLLs) which reduce the overall power available for localization signal transmission.

Systems and methods in accordance with a variety of embodiments of the invention can remedy these problems by introducing a fully battery-less and wirelessly powered localization system that can also monitor physiological motions of the body. Compared to traditional, battery-powered WCEs, wireless power delivery is used to mitigate the risk of battery failure and chemical poisoning. The wireless power transfer signal can be used to directly drive the localization signal, thereby eliminating the need for an oscillator or PLL. Further, systems and methods described herein enable improved precision localization using RF-based localization techniques that avoids field interference introduced by magnetic localization systems. In many embodiments, described localizers are small enough to be implemented as part of a WCE. Many embodiments provide concise circuitry to realize an energy-efficient localization system using a wireless power transfer (WPT) system and near-field inductive coupling. Further, unlike conventional systems that operating in the hundreds-MHz range, on-chip coils, many embodiments of the localization system implement a miniaturized Rx coil on a printed circuit board (PCB) to minimize manufacturing cost.

Discussed below are localization systems that are wirelessly powered and provide improved precision localization. Circuit implementations are described with a focus on the design tradeoffs in the energy-harvesting frontend circuitry in accordance with several embodiments of the invention. Furthermore, a discussion of the benchtop measurement and in vivo experiment results is provided. While the following is discussed in the context of WCEs, as can be readily appreciated, the wireless power and localization circuitry can be easily adopted into any number of deployable wireless sensors both within and outside of the medical context.

### Localization Systems

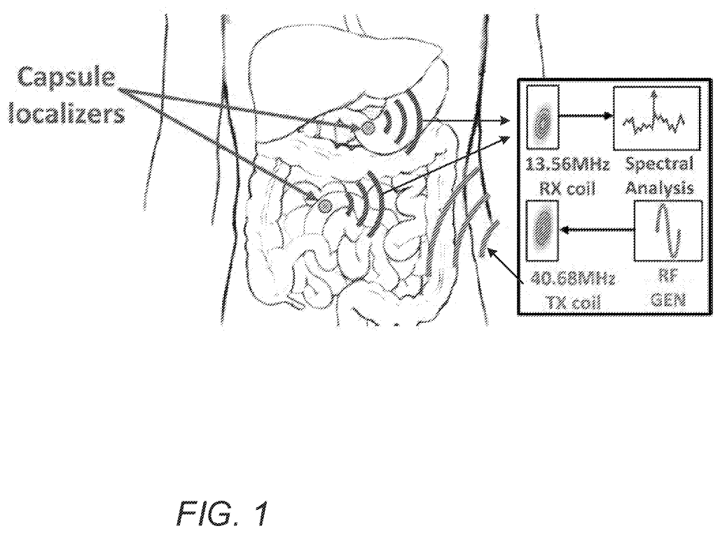

Localization systems as described herein are both wirelessly powered and transmit RF localization signals. These localization systems can both harvest an RF power transfer signal to power the device, as well as utilize the power transfer signal to directly drive the transmission of one or more separate localization signals at a different frequency than the power transfer signal. Turning now to FIG. 1, conceptually illustrates operation of two swallowed WCEs utilizing localization systems as described herein which are providing location information in accordance with an embodiment of the invention. In many embodiments, the energy-harvesting frontend circuitry accounts for the potential impacts of biological tissues. In several embodiments, the finalized localizer has a small form factor of 17 mm×12 mm×0.2 mm and consumes an average power of 6 μW. An external Tx antenna generates and transmits RF signals that are used to power the localizers, and an external Rx antenna receives signals transmitted from the localizer that indicates the various status of the localizers. In numerous embodiments, the external Tx and Rx antennas are part of a single control unit. The diameter of the Tx antenna is 35 mm and the diameter of the external Rx antenna is 45 mm in many embodiments of the invention. In many embodiments, physiological movements in the environment surrounding the localizers were observed during stimulation experiments.

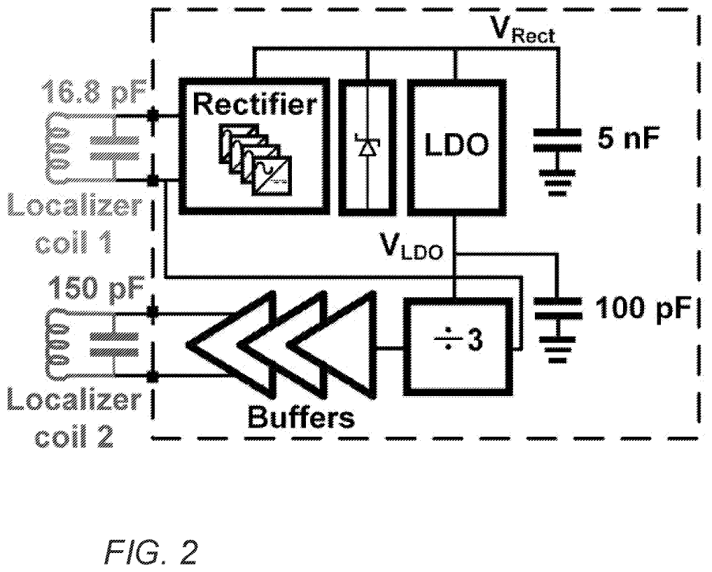

A systematic architecture of a localizer in accordance with an embodiment of the invention is illustrated in FIG. 2. In numerous embodiments, the localizer includes an IC wire-bonded on a PCB and two planar localizer coils fabricated on the same PCB. In several embodiments, each of these coils has a diameter of 8 mm. The size of the coils on the localizer can be constrained to reduce the overall size of the localizer. Smaller localizers can allow for easier placement into the human body. Reducing the size of coils also meant that the widths of coil traces may be reduced, which in turn can reduce the thickness of the substrate the IC is implemented on.

In many embodiments, the IC includes a cross-coupled rectifier, a low dropout regulator (LDO), and a digital frequency divider circuit. In several embodiments, the frequency divider circuit is a divide-by-3 circuit. Localizer coil 1 is an antenna that receives the wireless power transfer signal transmitted from the external Tx antenna. The Tx antenna couples a continuous-wave sinusoidal RF signal to localizer coil 1. Localizer coil 1 is connected to the input of the rectifier, where the received RF signal is harvested by the rectifier. The rectifier generates a DC voltage at the input of the LDO. The LDO then generates a regulated supply voltage for the frequency divider circuit. The frequency divider may divide the frequency of the RF signal by 3, and generate a localization signal at its output that is connected to localizer coil 2. In many embodiments, localizer coil 2 is coupled to the external Rx antenna and can transmit signals containing information relating to the status of the localizer by modulating the localization signal. Using two separate frequencies for transmitting and receiving can reduce interference of the received signal with the Tx power signal to provide more localization accuracy. In many embodiments, the WPT link is optimized to facilitate reliable wireless powering of the system at a maximum distance of 40 mm with 2 W of external power.

In numerous embodiments and as empirically described below, the power transfer signal is 40.68 Mhz, which is divided into a 13.56 Mhz localization signal. However, as can be readily appreciated, any number of different frequencies can be used as appropriate to the requirements of specific applications of embodiments of the invention. While the below discusses localization systems utilizing these particular frequencies, as can be readily appreciated, this is for illustrative purposes only in the context of provided validating data, and it should be understood that different frequencies may be selected without departing from the scope or spirit of the invention.

Although a specific example of a localizer is described above with reference to FIG. 2, any of a variety of circuit configurations can be utilized to fabricate a localizer similar to those described herein as appropriate to the requirements of specific applications in accordance with various embodiments of the invention. Wireless power harvesting is discussed in further detail below.

### WPT Link Design

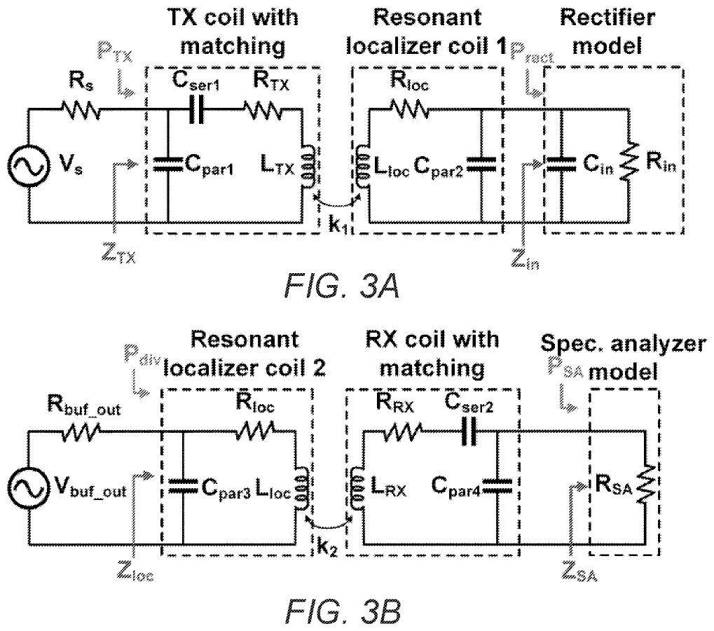

The wireless power transfer signal received at localizer coil 1 can be used for both delivering power to the device, as well as to drive transmission of a localization signal. FIGS. 3A and 3B illustrate circuit models for the WPT link between the Tx coil and localizer coil 1, and localizer coil 2 and the Rx coil in accordance with an embodiment of the invention. The link efficiency (ηₗᵢₙₖ) is given by the product of the efficiency of the localizer coil (η_{loc}) and the Tx coil (η_{TX}). The maximum η_{TX} that can be obtained when the operating frequency is equal to the resonant frequency (ωᵣₑₛ) of the localizer coil. Since the input resistance of the rectifier (Rᵢₙ) is much larger than the resistance of the localizer coil (R_{loc}), a parallel capacitance Cₚₐᵣ₂ may be used to resonate the localizer coil at its operating frequency. In such a topology, ωᵣₑₛ is given by

$${ω}_{res}^{2} = \frac{1}{{L}_{loc} ( {C}_{par 2} + {C}_{i n} )} \qquad ( 1 )$$

where L_{loc} is the inductance of the localizer coil and Cᵢₙ is the input capacitance of the rectifier as shown in FIG. 3A.

Similarly, Cₚₐᵣ₃ can be used to resonate localizer coil 2 at its operating frequency of 13.56 MHz. Off-chip ceramic capacitances Cₚₐᵣ₂ and Cₚₐᵣ₃ of values 16.8 pF and 150 pF respectively can be connected in parallel to the localizer coils, improving the power received and transmitted by the localizer at these desired frequencies. η_{loc}, η_{TX}, and ηₗᵢₙₖ of the link are then given by:

$${η}_{l o c} = \frac{{Q}_{{loc}_{L}}}{{Q}_{r e c t}} \qquad ( 2 )$$

$${η}_{T X} = \frac{{k}^{2} {Q}_{T X} {Q}_{l o {c}_{L}}}{{k}^{2} {Q}_{T X} {Q}_{{loc}_{L}} + 1} \qquad ( 3 )$$

$${η}_{link} = {η}_{loc} {η}_{T X} \qquad ( 4 )$$

where Q_{rect} is the quality factor of the load given by

$${Q}_{r e c t} = \frac{{R}_{i n}}{ω {L}_{l o c}} \cdot {Q}_{l o {c}_{L}}$$

is the loaded quality factor of the localizer coil given by

$${Q}_{l o {c}_{L}} = \frac{{Q}_{loc} {Q}_{rect}}{( {Q}_{l o c} + {Q}_{r e c t} )} \cdot {Q}_{TX}$$

is the quality factor of the Tx coil given by

$${Q}_{T X} = \frac{ω {L}_{T X}}{{R}_{T X}} ,$$

and k is the distance-dependent coupling factor between the Tx coil and the localizer coil. The coupling factor can be determined from the self and mutual inductances of the coils or can also be empirically given by

$$k = \frac{{d}_{T X}^{2} {d}_{l o c}^{2}}{8 \sqrt{{d}_{T X} {d}_{l o c}} {( {D}^{2} + \frac{{d}_{T X}^{2}}{4} )}^{3 / 2}} \qquad ( 5 )$$

where d_{TX} and d_{loc} are the diameters of the Tx coil and localizer coil, respectively, while D is the distance between these coils. The diameter of the localizer coils is constrained to 8 mm to minimize the form factor of the entire system, thereby enabling the use of these localizers in capsules for endoscopy.

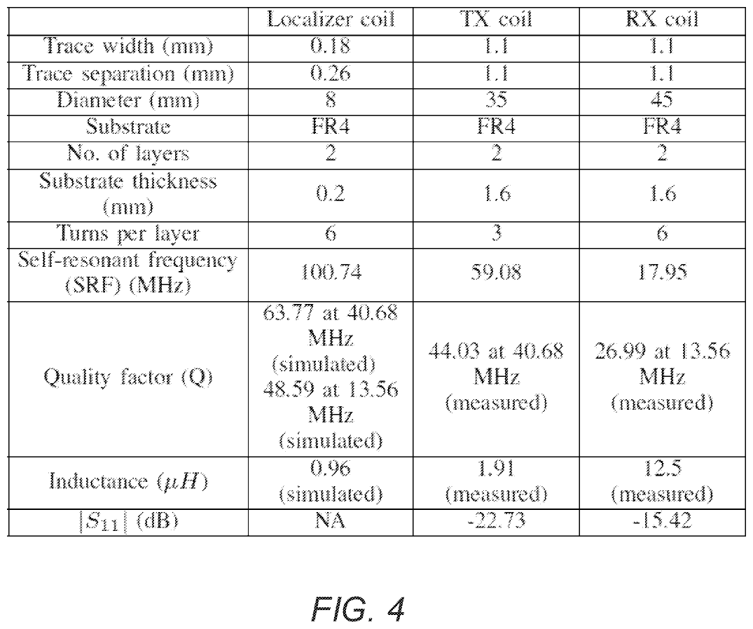

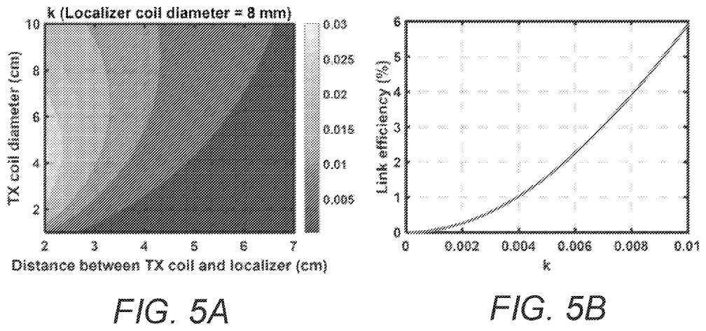

FIG. 4 illustrates the details of coil design parameters in accordance with an embodiment of the invention. FIG. 5A illustrates the coupling factors obtained using equation (5) for a localizer coil diameter of 8 mm as the diameter of the Tx coil and distance between the Tx coil and localizer are varied. At a distance of 4 cm, a maximum coupling factor of 0.01 can be obtained for a Tx coil diameter of 10 cm. The coupling factor does not vary by large amounts at larger distances when the diameter of the Tx coil is increased. Therefore, in some embodiments, a diameter of 3.5 cm is chosen for the Tx coil. FIG. 5B illustrates the calculated link efficiency versus coupling factor in accordance with an embodiment of the invention. The link efficiency is calculated using equations (2), (3), and (4) as a function of the coupling factor at a distance of 4 cm between the Tx coil and localizer. The parameters of the designed Tx coil and localizer coil given in FIG. 4 have been chosen. A maximum of 6% link efficiency can be obtained for a coupling factor of 0.01. From equation (4), it can be deduced that the link efficiency increases with an increase in the values of k, Q_{TX} and Q_{loc}. The larger self-inductance of the Tx coil and localizer coil can improve the link efficiency for WPT by increasing the quality factor of each of these coils. Specific circuit designs for WPT links are described in further detail below.

### WPT Link Circuit Implementation

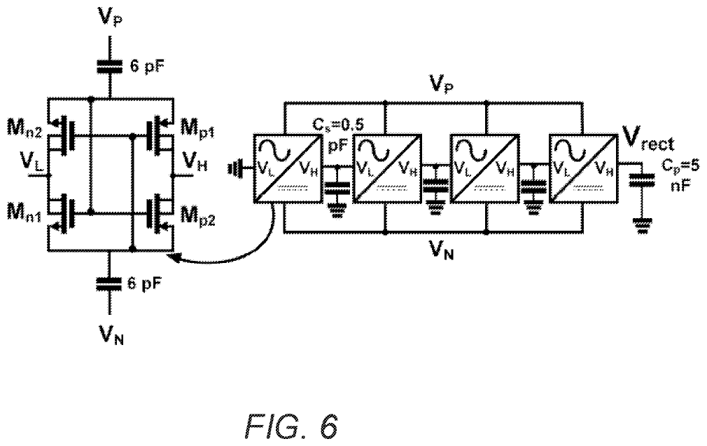

In many embodiments, the received wireless power transfer signal needs to be processed by a number of circuit components on the localizer in order to be converted to a stable and usable DC voltage to power the localizer. FIG. 6 illustrates a circuit schematic of rectifiers in accordance with an embodiment of the invention. In numerous embodiments, a passive four-stage full-wave CMOS rectifier incorporating a cross-coupled topology is used to obtain the desired DC voltage without using a battery. The cross-coupled topology is chosen due to its superior sensitivity and power conversion efficiency (PCE). A better sensitivity can ensure that sufficient DC voltage may be generated by the rectifier to power the IC even when the rectifier has a cold start at a lower input RF power, and a better PCE can ensure a better link efficiency between the Tx antenna and localizer coil 1. In several embodiments, deep n-well NMOS transistors are used to enable the connection between source and bulk, therefore reducing the source-bulk potential and consequently the threshold voltage, leading to better sensitivity. Deep n-well can help prevent leakage through the bulk of the devices due to an increase in the bulk potential, therefore decreasing the possibility of a reduction of PCE. In some embodiments, the coupling capacitor values are chosen to pass the signal with less than 1% attenuation, and transistors are sized to maximize the PCE across all process corners. In numerous embodiments, a limiter is included at the output of the rectifier to prevent the breakdown of transistors due to high voltage generation in accordance with embodiments of the invention.

When V_{P} is greater than V_{N}, transistors Mₚ₁ and Mₙ₁ are turned on, while transistors Mₚ₂ and Mₙ₂ are turned off. The charge on the coupling capacitor connected to V_{P} can therefore be used to charge the output node of the rectifier stage V_{H}. On the other hand, when V_{N} is greater than V_{P}, transistors Mₚ₂ and Mₙ₂ are turned on, while transistors Mₚ₁ and Mₙ₁ are turned off. In this half cycle, the charge on the coupling capacitor connected to V_{N} can be used to charge V_{H}. The PCE of a rectifier is the ratio of the power delivered to the load at the output of the rectifier P_{OUT} to the RF power supplied at its input P_{RF}. It is given by

$$PCE = \frac{{P}_{O U T}}{{P}_{R F}} = \frac{{P}_{O U T}}{{P}_{OUT} + {P}_{LOSS}} \qquad ( 6 )$$

where P_{LOSS} is the effective power loss in the rectifier. An important parameter in the design of the rectifier is its bandwidth given by

$$B W = \frac{{f}_{0}}{{Q}_{rect}} \qquad ( 7 )$$

where f₀ is the operating frequency and Q_{rect} is the quality factor of the rectifier, as defined earlier. Since Cᵢₙ of the rectifier varies with input power, ωᵣₑₛ computed using equation (1) can also change. A higher rectifier bandwidth is, therefore, essential for reliable wireless powering of the localizer. The rectifier is simulated for an output voltage of 1.1V using an input 40.68 MHz RF signal of power ranging from −80 dBm to 0 dBm at a constant load current of 12.75 μA, which is the maximum current that the LDO draws from the rectifier output.

Although a specific example of a rectifier is described above with reference to FIG. 6, any of a variety of circuit configurations can be utilized to fabricate a rectifier similar to those described herein as appropriate to the requirements of specific applications in accordance with various embodiments of the invention.

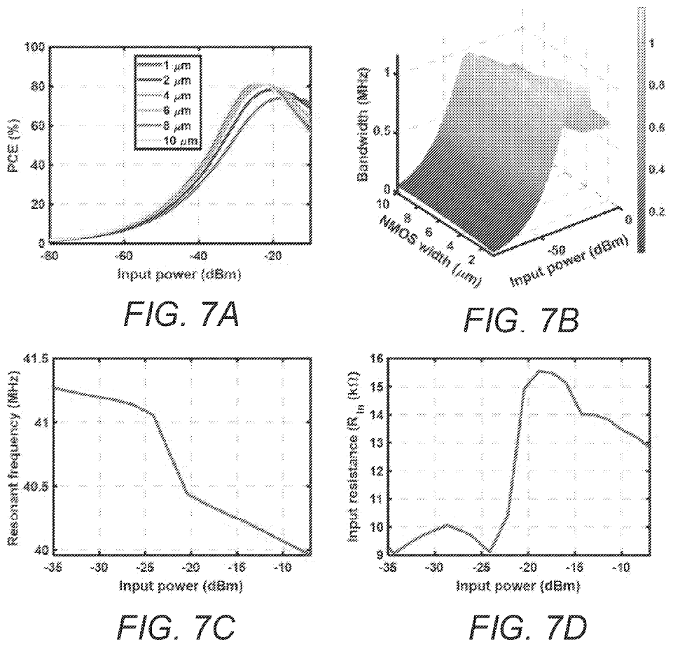

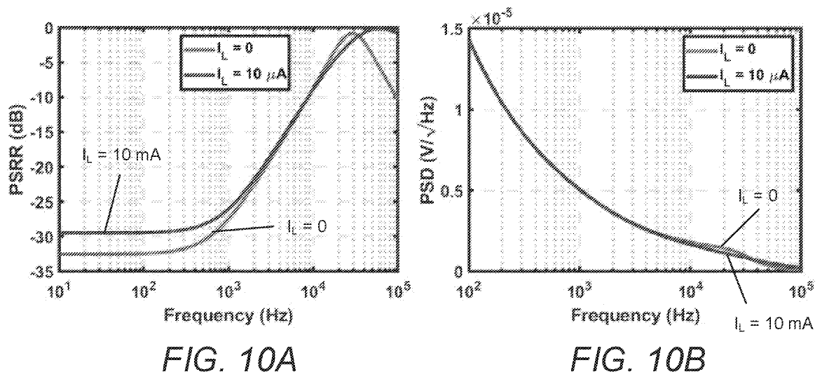

FIGS. 7A-B illustrate the PCE and bandwidth of the rectifier for different NMOS transistor widths and input powers in accordance with embodiments of the invention. Higher PCE can be obtained using larger transistors, but the bandwidth may drop due to increased input resistance. Therefore, in many embodiments, the aspect ratio of NMOS transistors is chosen to be 4 μm/0.18 μm. The PMOS transistor widths are chosen to be double that of the NMOS transistors. FIG. 10C illustrates the variation in the resonant frequency of the localizer ωᵣₑₛ due to the variation in Cᵢₙ of the rectifier with input power, while FIG. 10D illustrates the variation in its input resistance Rᵢₙ for the selected transistor aspect ratio in accordance with an embodiment of the invention. Since this variation in Rᵢₙ only changes the path loss between the Tx coil and the localizer coil 1 by 2 dB, it can be concluded that the rectifier has enough bandwidth to withstand the changes in ωᵣₑₛ.

Another critical parameter is the sensitivity of the rectifier, which is defined as the minimum RF power required at its input for generating the minimum required voltage at its output for proper operation of the circuit at the desired load. Reducing the rectifier sensitivity is therefore crucial for increasing the link efficiency and, subsequently, the operating range of the WPT system. Therefore, the cross-coupled topology was chosen as it can provide superior sensitivity and PCE among its counterparts. In many embodiments, deep n-well NMOS transistors are used to enable the connection between source and bulk, reducing the source-bulk potential for the subsequent rectifier stages and the threshold voltage, leading to better sensitivity and PCE. An LDO output voltage of 1.1 V is targeted, while the LDO has a dropout voltage of 47.64 mV. Therefore, in many embodiments, the minimum rectifier output voltage for proper operation is approximately equal to 1.16 V. The sensitivity of the rectifier simulated at an output voltage of 1.16 V and a load current of 12.75 μA is obtained to be equal to 32 μW. For each stage, coupling capacitors of 6 pF are chosen to couple the signal to the input of the rectifier with an attenuation of less than 1%. A 5 nF on-chip storage capacitor Cₚ is used to reduce the ripple at the output of the rectifier. A diode limiter may be used to limit the rectifier output voltage V_{rect} to less than 3.8 V, therefore preventing the breakdown of transistors.

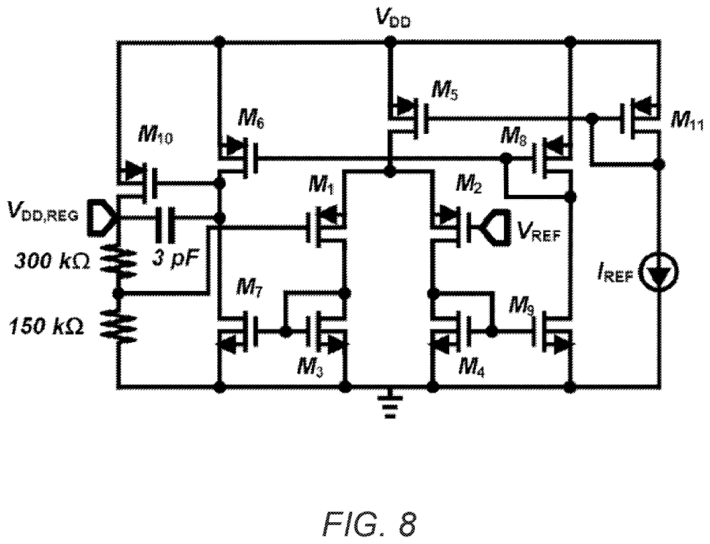

FIG. 8 illustrates a circuit schematic of the LDO in accordance with an embodiment of the invention. The output of the rectifier can act as the line voltage of the LDO. The LDO can generate a regulated DC voltage of 1.1 V at its output, which is used as the supply voltage for the IC. The LDO may include an error amplifier that compares a reference voltage of 336 mV and the voltage generated by the resistive division of the output. The reference voltage may be generated using a bandgap reference generator with proportional-to-absolute-temperature (PTAT) architecture.

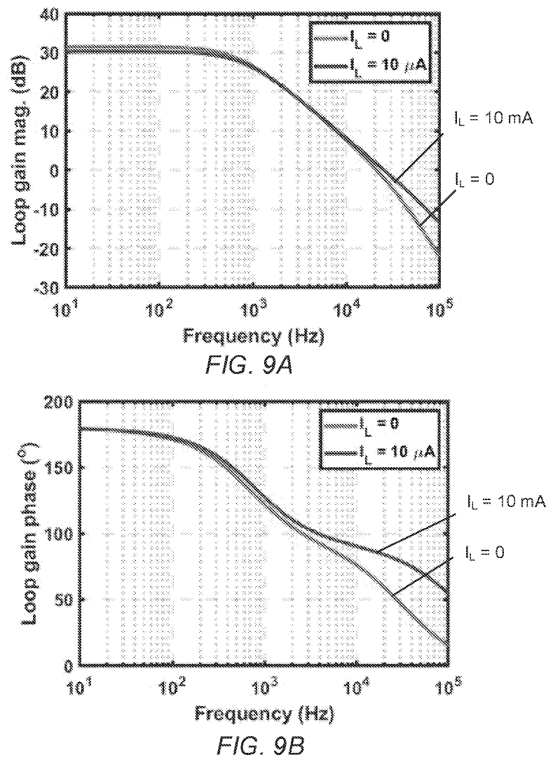

The pass transistor of an LDO can either be a PMOS device acting as a voltage-controlled current source (VCCS) or an NMOS device acting as a source follower. LDOs with current source pass transistors can have higher loop gain and lower dropout voltage. Therefore, an LDO with a current source is used in the design. The pass transistor in such a topology is typically a large device to reduce the dropout voltage, which can cause a large current to flow through the pass transistor, making it the most power-hungry part of the LDO. In many embodiments, the pass transistor is sized appropriately to generate a low dropout voltage at the highest load current, and the feedback resistor values of 300 and 150 kΩ are chosen to minimize quiescent power consumption. In some embodiments, the LDO requires a smoothing capacitor of 100 pF, which can be implemented on-chip. For an LDO with an on-chip output capacitor, the worst-case stability condition occurs when the load current is zero. Therefore, based on the value of the smoothing capacitor, in several embodiments, a 3 pF Miller compensation capacitor is chosen to increase LDO stability under the zero-load current condition. FIGS. 9A-B illustrate the simulated magnitude and phase of the loop gain of the LDO under zero and 10 μA load current conditions in accordance with embodiments of the invention. The LDO has a low-frequency loop gain of 31.53 dB and a phase margin of 57.79 degrees at a unity-gain bandwidth of 21.14 kHz when the load current is zero. The loop gain drops to 30.3 dB, and the unity-gain bandwidth increases to 25.22 kHz when the load current is 10 μA.

Specifications of the LDO include the quiescent current consumption, which is the static current consumed by the LDO when the load current is zero. Line and load regulations are other important specifications that quantify the variation in the LDO output voltage with changes in line voltage and load current at steady state and are defined as

$$Line Regulation = \frac{{Δ V}_{L D O}}{{Δ V}_{Rect}} {\vert}_{t \to ∞} * 100 \% \qquad ( 8 )$$

$$Load Regulation = \frac{{Δ V}_{L D O}}{{Δ V}_{LOAD}} {\vert}_{t \to ∞} \qquad ( 9 )$$

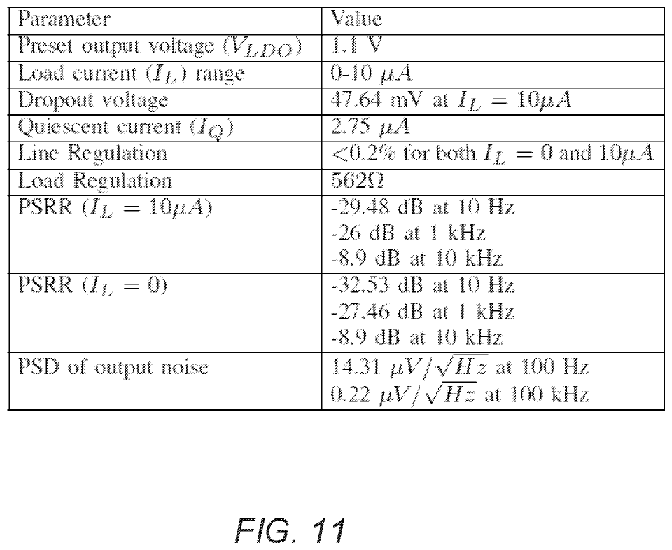

The load regulation of the LDO is related to its closed-loop DC output resistance. The power supply rejection ratio (PSRR) measures the amount of ripple at the output of the LDO due to a ripple at its input. Therefore, the line regulation of an LDO is equal to its PSRR at DC. FIG. 10A illustrates the simulated PSRR of the LDO, while FIG. 10B illustrates the power spectral density (PSD) of the noise at the LDO output in accordance with an embodiment of the invention. FIG. 11 illustrates the specifications of the LDO in accordance with an embodiment of the invention. In some embodiments, the LDO has a dropout voltage of 47.64 mV and consumes 4.96 μW of static power.

Although a specific example of an LDO is described above with reference to FIG. 11, any of a variety of circuit configurations can be utilized to fabricate an LDO similar to those described herein as appropriate to the requirements of specific applications in accordance with various embodiments of the invention.

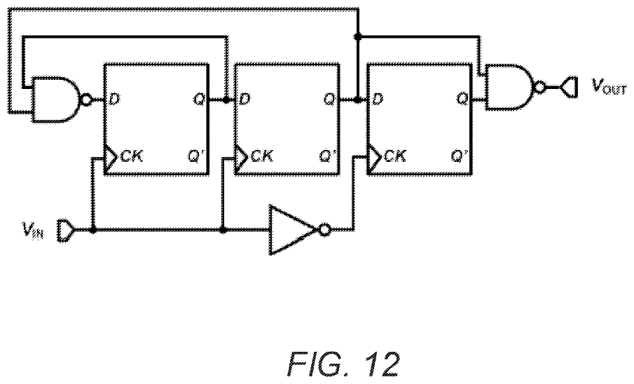

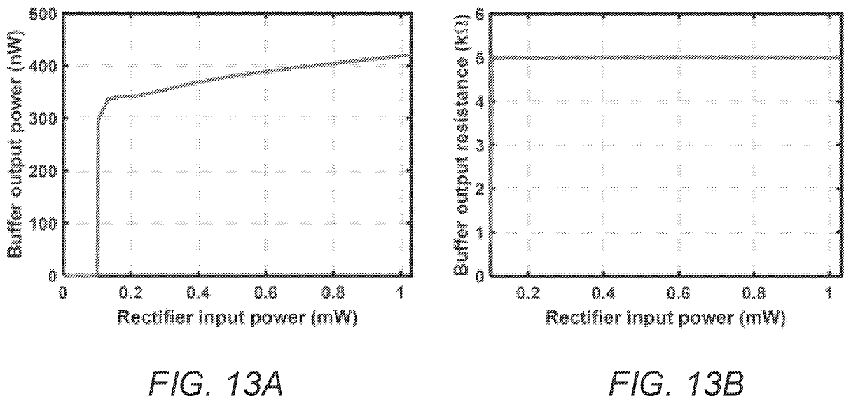

FIG. 12 illustrates a circuit schematic of a divide-by-3 circuit in accordance with an embodiment of the invention. The divide-by-3 circuit may include a mod-3 counter and an additional D flip-flop to generate a 50% duty cycle signal at its output. In some embodiments, the designed flip-flops are conventional master-slave flip-flops and have an asynchronous set-reset functionality. In many embodiments, the divide-by-3 circuit consumes 1 μW power. FIG. 13A illustrates the power at the output of the buffer following the divide-by-3 circuit with respect to the input power of the rectifier when the buffer is loaded with the circuit parameters of localizer coil 2 in accordance with an embodiment of the invention. The sensitivity of the localization system may be determined by the rectifier and divider-buffer combination. The sensitivity of the divider-buffer combination may be defined as the minimum power at the input of the rectifier, for which it generates a detectable 13.56 MHz signal at the output of the buffer. From FIG. 13A, it can be observed that the sensitivity of the divider-buffer combination is 99 μW. The sensitivity of the divider-buffer combination, therefore, dominates over that of the rectifier. FIG. 13B illustrates the output resistance of the buffer with respect to the input power of the rectifier in accordance with an embodiment of the invention. It can be observed that once the divider-buffer combination turns on, the buffer has a constant output resistance of around 5 kΩ.

Although a specific example of a divide-by-3 circuit is described above with reference to FIG. 12, any of a variety of circuit configurations can be utilized to fabricate a divide-by-3 circuit similar to those described herein as appropriate to the requirements of specific applications in accordance with various embodiments of the invention.

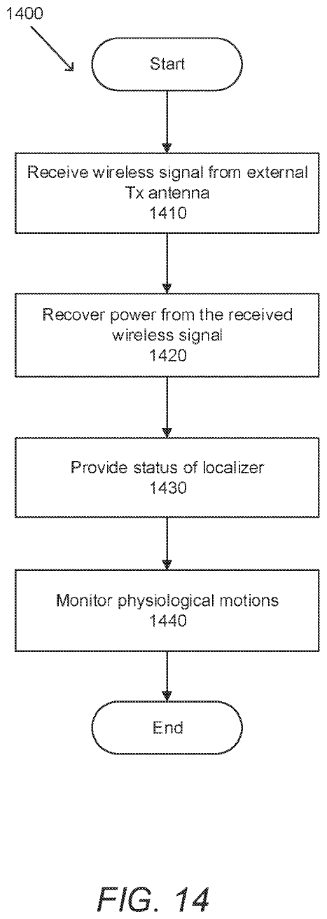

A process for operating a battery-less, wirelessly powered localization system in accordance with an embodiment of the invention is illustrated in FIG. 14. Process 1400 receives (1410) a wireless signal from an external Tx antenna. In numerous embodiments, the wireless signal provided by the external Tx antenna is an RF power transfer signal. Process 1400 recovers (1420) power from the received RF signal. In many embodiments, the transmitted RF signal is received by a localizer and converted to a stable DC voltage. Process 1400 can use a portion of the recovered power to power the localizer at a divided frequency of the power transfer signal. Process 1400 provides (1430) a status of the localizer to an external Rx antenna. In several embodiments, both the external Tx antenna and the external Rx antenna can be moved over a patient carrying the localizer to identify the location of the localizer. When the external Tx antenna and the external Rx antenna are near the localizer, the external Tx antenna can power the localizer while the external Rx antenna can receive the status of the localizer. The location of the localizer can be identified when the external Rx antenna is placed over a location on the patient such that the received localization signal power is at its maximum. The location of the localizer may be further refined based on the orientation of the external Rx antenna. Process 1400 monitors (1440) physiological motions of the environment around the localizer using the localizer.

While specific processes for operating a battery-less, wirelessly powered localization system are described above, any of a variety of processes can be utilized to operate the localization system as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

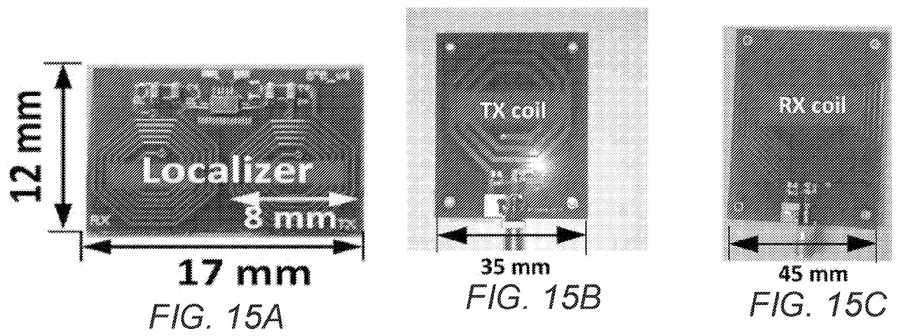

FIGS. 15A-C illustrate the fabricated localizer, and the Tx and Rx antennas in accordance with an embodiment of the invention. The localizer, and the Tx and Rx antennas may be fabricated on a two-layer FR4 substrate. In many embodiments, the diameter of the localizer coils is constrained to 8 mm to reduce its form factor. Since the inductance of such small-sized coils is very low, the trace widths of these coils can be minimized while the number of turns can be maximized. The thickness of the substrate may also be reduced to obtain the maximum possible value of inductance. In many embodiments, the coils are fabricated on a 0.2 mm thick two-layer FR4 substrate with 6 turns on each layer. In performance simulations, localizer coil 1 connected to the rectifier input is tuned by a high Q-factor capacitance of 16.8 pF to resonate at 40.68 MHz, while localizer coil 2 connected to the divide-by-3 output is tuned by a capacitance of 160 pF to resonate at 13.56 MHz.

### Measurement Results

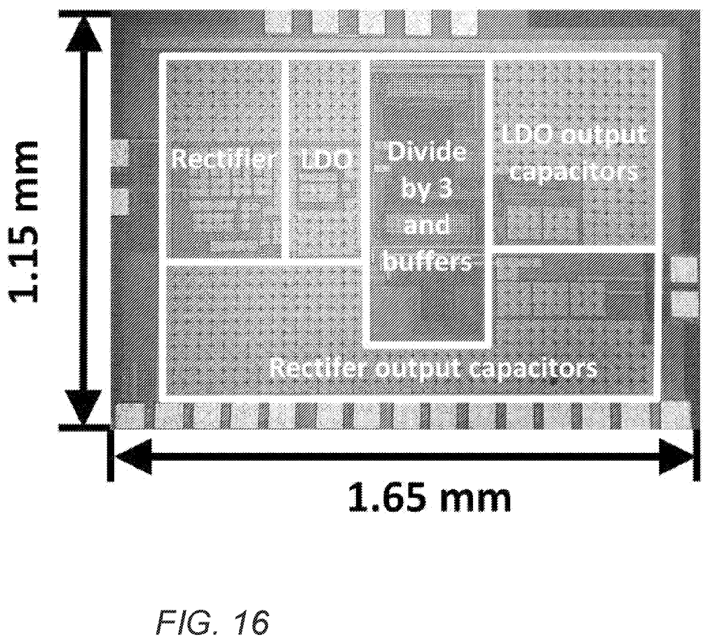

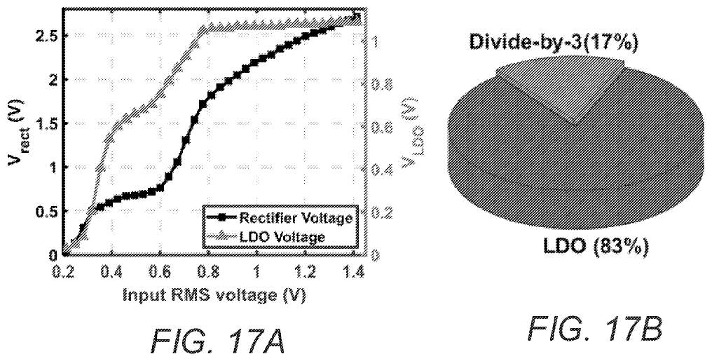

Localization systems as described herein have been empirically validated via testing. Test results are provided for illustrative and informational purposes. FIG. 16 illustrates a microscopic image of a fabricated localizer without two 8 mm coils in accordance with an embodiment of the invention. The localizer may be minimized down to 1.65 mm in length and 1.15 mm in width and can be fabricated using TSMC 0.18 μm process. In a separate setup for wired measurements, a 40.68 MHz RF signal was connected to the input of the rectifier using an RF generator. The voltage at the output of the rectifier and the LDO were then measured using an oscilloscope. FIG. 17A illustrates the rectifier and LDO output voltages with respect to input root-mean-square (RMS) voltage in accordance with an embodiment of the invention. The rectifier output voltage increased with an increase in the input rms voltage, and the rate of increase starts to reduce after a certain input rms voltage. This was due to the reduction in PCE of the rectifier as the input power is increased. The LDO generated a stable DC voltage of 1.05 V for an input rms voltage above 0.8 V. The LDO output voltage was close to the simulated value of 1.1 V. The total simulated power consumption of the IC was equal to 6 μW. FIG. 17B illustrates the breakdown of the power consumption of the IC in accordance with an embodiment of the invention. The LDO dominated the power consumption of the IC.

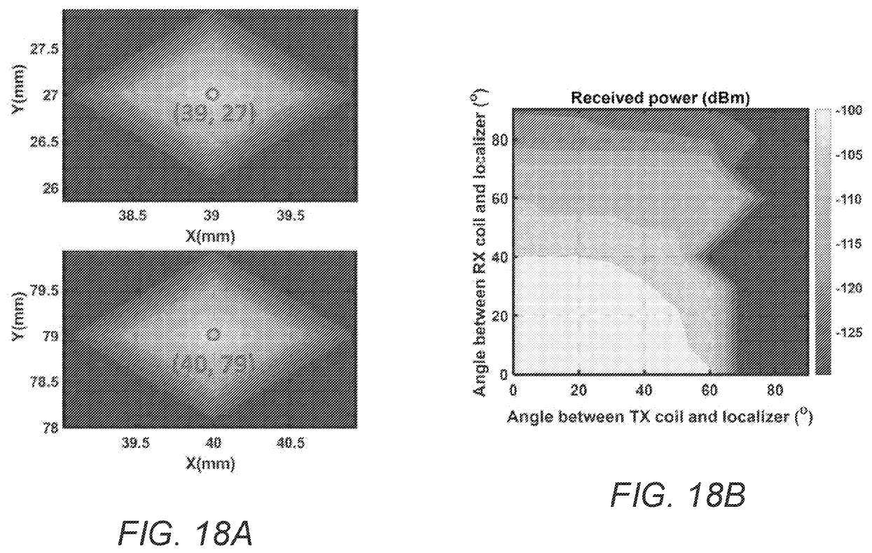

FIGS. 18A-B illustrate the results of evaluating the effectiveness of the localization system in accordance with an embodiment of the invention. Two localizers were placed having centers at coordinates of (40, 30) mm and (40, 75) mm. A 40.68 MHz RF signal having −20 dBm power was generated using the RF signal generator, and was delivered using the RF signal generator and the power amplifier (PA) to the external Tx antenna, which was placed 4 cm from the localizers. A PA was connected in cascade with the RF signal generator to increase the operating range of the wireless link. The PA had a small-signal gain of 50 dB and a saturated output power of 43 dBm. Therefore, the boosted RF signal of 30 dBm power was delivered to the Tx coil for wireless powering of the IC. The Tx coil was placed at a distance of 4 cm from the localizers. The localizers received the boosted RF signal, divided the frequency of the signal by 3, and transmitted back a 13.56 MHz signal to the Rx antenna, which was placed 10 cm from the localizers. The external Rx antenna was connected to a spectrum analyzer to record the signal, which in turn was connected to a laptop for data processing. The coils were moved with a resolution of 1 mm using motorized rails in the X and Y-direction and the spectrum at each coordinate was recorded.

Motorized rails were interfaced with MATLAB and used to automate the simultaneous movement of the Tx and Rx coils to scan the entire area with a 1 mm resolution in the X and Y directions. At each coordinate, the spectrum was recorded using a spectrum analyzer connected to the Rx coil. The spectrum analyzer was also interfaced with a laptop for data processing using MATLAB. The coordinate with the maximum received signal power was extracted as the experimentally obtained locations. FIG. 18A illustrates the extracted coordinates obtained for the localizers placed at (40, 30) mm and (40, 75) mm after processing the spectral data using MATLAB. The obtained coordinates had an error of less than 5 mm. T paper protractors were added around the Tx and Rx coils, and the coils were rotated to measure the received power of the 13.56 MHz signal at different angular orientations of the Tx and Rx coils with respect to the localizer. A separation of 3.5 cm was used between the Tx coil and the localizer, while a separation of 10 cm was used between the Rx coil and the localizer. The noise floor for these measurements was observed to be at −128 dBm. FIG. 18B illustrates the contour plot of the received power across different angular orientations. In case of misalignment between the Tx/Rx coil and the localizer, it can be observed that the received power and the SNR reduced, but this did not affect the spread of the received power, which was determined by the size of the localizer coils. Therefore, the misalignment did not increase localization error. If the minimum SNR required is constrained to 20 dB (chosen only for the purpose of quantifying an acceptable level of misalignment), it can be observed that the system was fairly robust to angular misalignments of up to 60° between the Tx coil and localizer and up to 70° between the Rx coil and localizer. Increasing or decreasing the minimum SNR requirement led to the detection of the 13.56 MHz tone for smaller or larger angular misalignments between the Tx/Rx coil and the localizer.

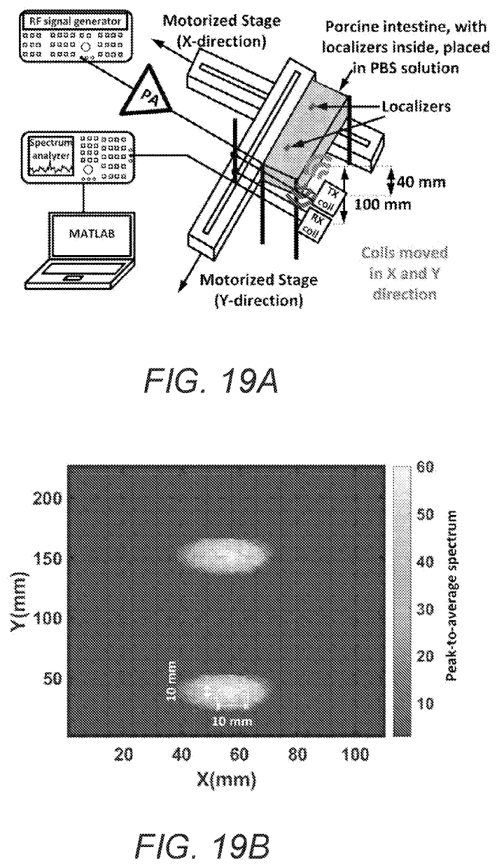

FIGS. 19A-B illustrate a measurement setup used for ex vivo verification of the localization system using porcine intestine in accordance with an embodiment of the invention. Two localizers were placed in an unknown location inside the porcine intestine, and the intestine was placed inside a container filled with phosphate-buffered saline (PBS) solution. This was done to mimic the characteristics of animal tissue closely. The localizer was encapsulated with a thick layer of ultraviolet (UV) light-cured epoxy resin (BONDIC) before being used for the ex vivo measurement to prevent water and/or PBS solution from leaking into the microchip and causing electrostatic discharge (ESD). A 40.68 MHz RF signal of 36 dBm power was used in this experiment for wireless powering of the IC. A higher power was required due to the extra attenuation of the RF signal as it passes through the bottom of the container, PBS solution, and the intestine. The Tx and Rx coils were automated to move simultaneously using motorized rails with a resolution of 1 mm in both X and Y directions to scan the bottom surface of the container. At each coordinate, the spectrum was recorded by the spectrum analyzer and sent to MATLAB for processing. The peak-to-average ratio of the spectrum was used to quantify the strength of the received 13.56 MHz tone with respect to the noise floor. FIG. 19B illustrates the contour plot of the entire area constructed using peak-to-average values of the received spectrum at each coordinate. Assuming the estimated location of the localizers to be within the region with the brightest contour, the maximum possible localization error in both dimensions for the raw data was ±5 mm. The error depended on the spatial region where there was sufficient coupling between the Tx/Rx coil and the localizer coil. Since the localizer coils were much smaller than the Tx/Rx coils, the detection error was strongly related to the physical size of the localizer coils, which had a radius of 4 mm. It is important to note that the maximum error, in this case, was limited by the diameter of the localizer coil. Therefore, a smaller error could be obtained if a smaller localizer coil is used to transmit back. However, a smaller coil might lead to a reduction in the operating range of the system.

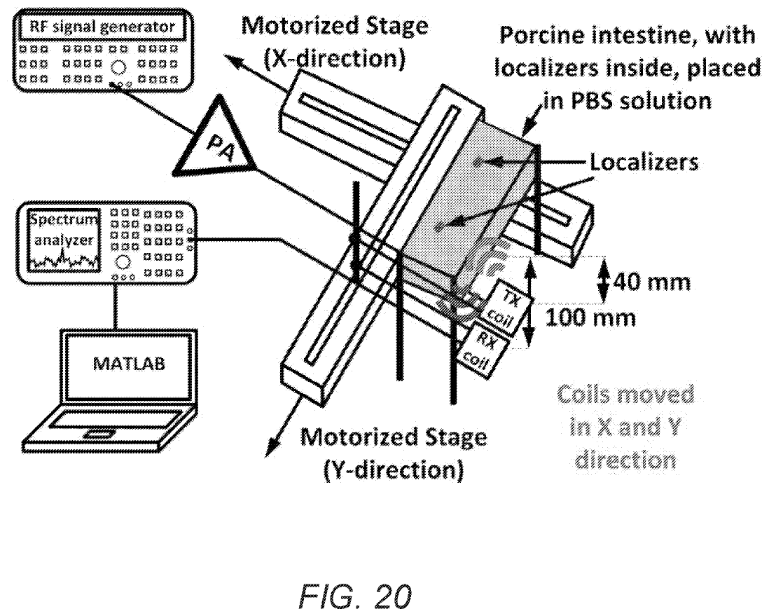

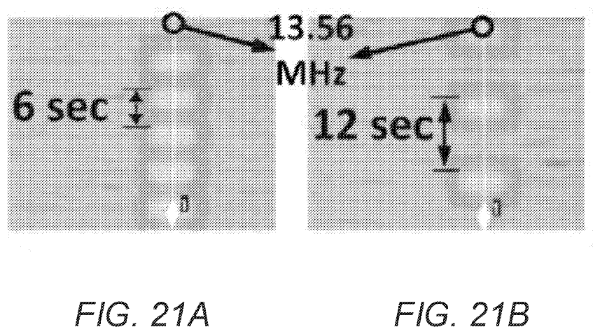

FIG. 20 illustrates a measurement setup verifying the functionality of sensing the rate of physiological motion in accordance with an embodiment of the invention. In two different variations of the measurement, the localizer was placed in air and PBS solution and periodically moved up and down by 4 mm at rates of 10 and 5 beats per minute using a motorized rail. Similar to the previous experiment, a 40.68 MHz RF signal of 36 dBm power was delivered to the Tx coil for wireless powering. The Tx and Rx coils were kept in a fixed position during this measurement, at average distances of 4 cm and 10 cm, respectively, from the localizer. The spectrum analyzer, connected to the Rx coil, recorded the variation of the received spectrum around 13.56 MHz with time for the entire duration of this measurement. FIGS. 21A-B illustrate the received spectrogram for the motion rates of 10 and 5 beats per minute respectively. For the measurements in both air and PBS, the magnitude and phase information of the spectrogram were then low-pass filtered to remove the 60 Hz supply noise, and the motion rate was extracted using MATLAB.

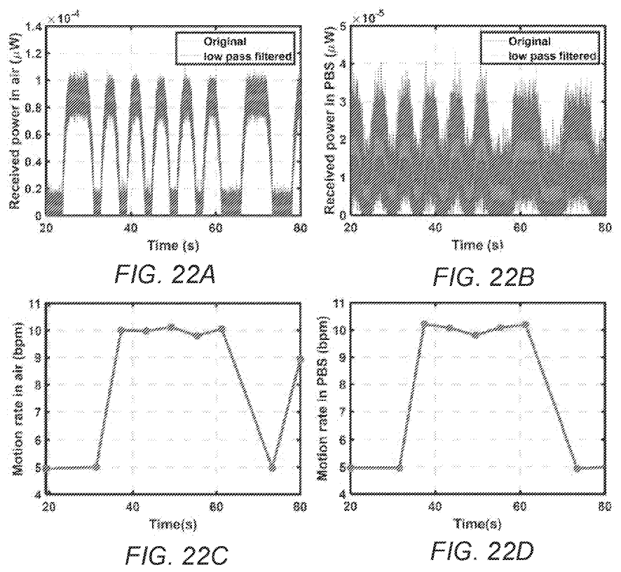

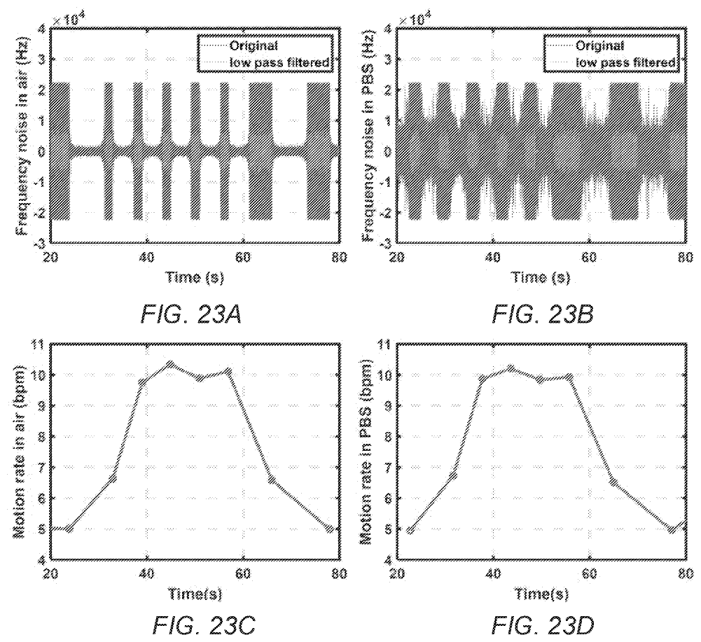

FIGS. 22A-B illustrate the signal power magnitude obtained from the magnitude of the received spectrogram when the localizer is placed in air and PBS solution respectively. It can be observed that the received signal power was around 90 μW when the coils were closest to the localizer and dropped to almost zero when the coils were farthest. FIGS. 22C-D illustrate the extracted motion rates from the received signal power when the localizer is placed in air and PBS solution respectively. FIGS. 23A and 23B illustrate the frequency noise obtained from the phase of the received spectrogram when the localizer is placed in air and PBS solution respectively. The frequency noise is defined as the difference between the expected signal frequency (13.56 MHz) and the frequency of the maximum tone received. It can be observed that the frequency noise was much larger when the coils were farthest from the localizer because the localizers were not powered in this position, and the received signal almost entirely consisted of noise. The frequency noise was much lesser when the coils are closest to the localizer. FIGS. 23C and 23D illustrate the extracted motion rates from the frequency noise of the received signal when the localizer is placed in air and PBS solution respectively.

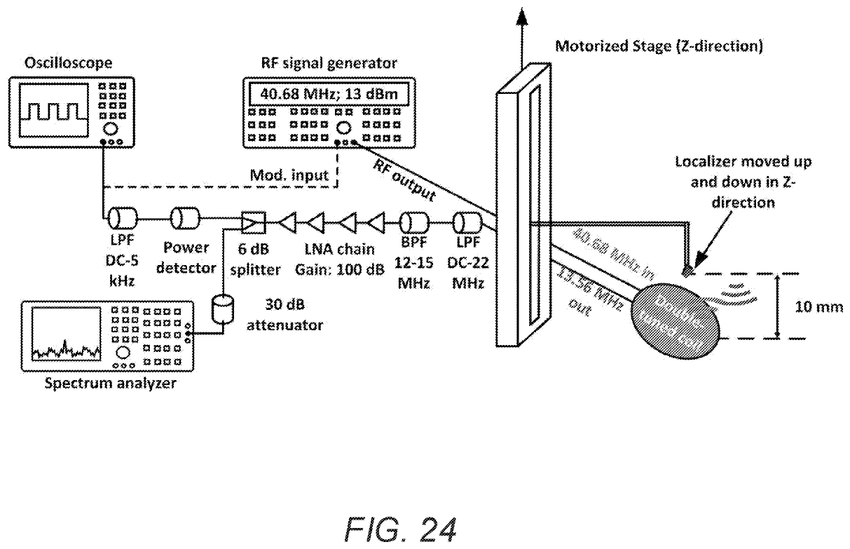

FIG. 24 illustrates a measurement setup used to sense the distance moved by the localizer in accordance with an embodiment of the invention. The power of the received signal was also used to modulate the 40.68 MHz Tx power signal, causing savings in Tx power. This improved the link efficiency for wireless powering while maintaining a minimum SNR for the received signal. A double-tuned double-input coil can be used for this measurement. The double-tuned coil was matched to the frequencies of 40.68 MHz (HF) and 13.56 MHz (LF) at the HF and LF inputs, respectively. It had a matching of −26.2 dB and −21.5 dB at HF and LF, respectively, and an isolation of −17.7 dB and −11.7 dB at each port. This coil acted as both the Tx and Rx coil and had been shown to reduce inter-coil couplings compared to a two-coil system of separate Tx and Rx coils. The localizer was placed at a distance of 10 mm from the double-tuned coil and was periodically moved up and down in the Z-direction by distances ranging from 50 to 1000 μm using a motorized rail. A 40.68 MHz RF signal of 13 dBm power was delivered to the double-tuned coil for wireless powering. Although a larger operating range can be obtained using a higher Tx power, it can significantly increase the coupling of the 40.68 MHz signal to the output, requiring more aggressive filtering to reject this coupled signal. It is important to note that the cascade of filters to reject the coupled 40.68 MHz signal is optional and has been used only to ensure that the received 13.56 MHz signal is visible in the time domain using an oscilloscope.

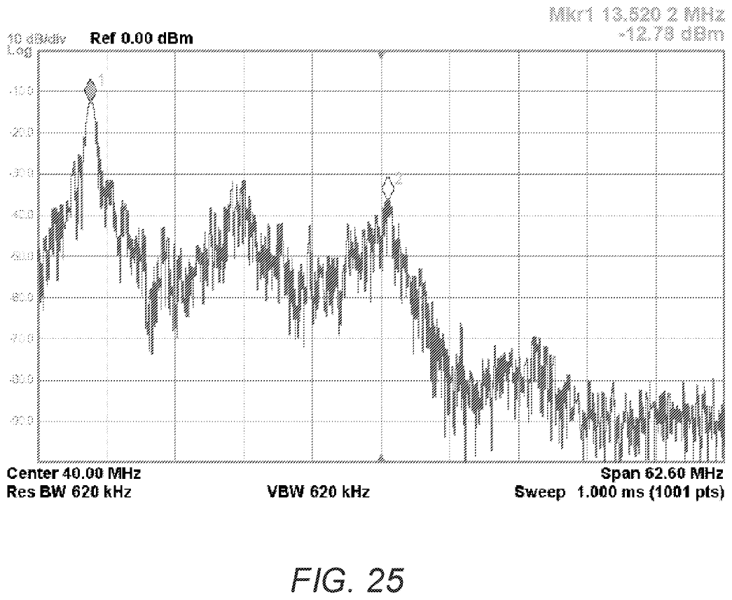

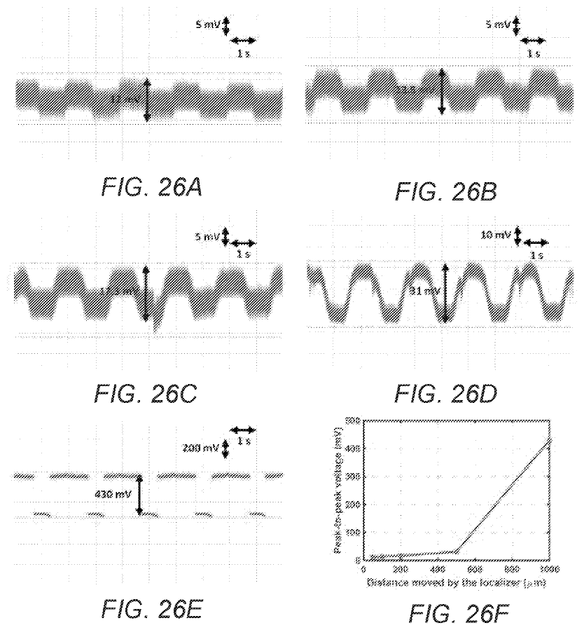

The motion detection measurements can be performed using just the spectrum analyzer to record a spectrogram of the received signal in the time domain. Since the power of the received 13.56 MHz signal at the LF input is needed to generate the modulation input for the 40.68 MHz RF source, the power of the received signal at the LF input was filtered out, and the 40.68 MHz coupled signal was rejected using the cascade of a low-pass filter (LPF) having a cut-off frequency of 22 MHz and a band-pass filter (BPF) having a passband between 12 and 15 MHz. The signal obtained after filtering was passed through a chain of low-noise amplifiers, providing a total gain of 100 dB. The resultant signal was then passed through a 6 dB splitter, and one of the branches was connected to a 30 dB attenuator followed by the spectrum analyzer. The other branch was used for detecting the power of the amplified and filtered signal using a power detector. The power detector output was passed through an LPF with a cut-off frequency of 5 kHz and sent to the oscilloscope for sensing. FIG. 25 illustrates the spectrum of the signal at the input of the power detector in accordance with an embodiment of the invention. FIGS. 26A-E illustrate the oscilloscope waveforms obtained when the localizers are moved by a distance of 50, 100, 200, 500, and 1000 μm respectively. FIG. 26F illustrates the peak-to-peak voltage obtained at the oscilloscope with respect to the distance moved in accordance with an embodiment of the invention.

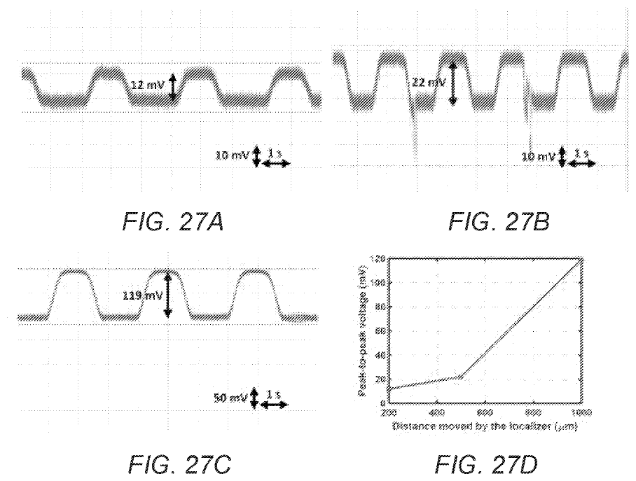

The oscilloscope input was then also connected to the modulation input of the RF signal source that generated the 40.68 MHz Tx signal. When the localizer was closer to the double-tuned coil, an increase in the power detected led to a more negative DC voltage generated at its output. When this voltage was fed back to the RF source, it reduced the power of the 40.68 MHz Tx signal. Similarly, when the localizer was farther away, a decrease in the power detected increased the power of the 40.68 MHz Tx signal. Therefore, this led to savings in Tx power. The modulation index of the RF signal source determined the savings in Tx power. At a modulation index of 100%, the Tx power could be reduced by a maximum of 3 dB. FIGS. 27 A-C illustrate the oscilloscope waveforms obtained when the oscilloscope input is connected to the modulation input of the RF source, and the localizers are moved by a distance of 200, 500, and 1000 μm respectively. FIG. 27D illustrates the peak-to-peak voltage obtained at the oscilloscope with respect to the distance moved in accordance with an embodiment of the invention.

Although specific implementations for a localization system are discussed above with respect to FIGS. 1-27, any of a variety of implementations utilizing the above discussed techniques can be utilized for a localization system in accordance with embodiments of the invention. As can be readily appreciated, specific embodiments enumerated in the measurement results section illustrate the efficacy of localization systems described herein, and are not intended to illustrate a single use case. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A wirelessly powered localization system, comprising:
an external transmit (Tx) antenna configured to generate a radio frequency (RF) power transfer signal that wirelessly powers at least one localizer;
an external receive (Rx) antenna configured to receive an RF localization signal transmitted from the at least one localizers; and
the at least one localizer, comprising:
an Rx antenna configured to receive the RF power transfer signal from an external Tx antenna;
a rectifier configured to generate a DC voltage using the received RF signal;
a low-dropout regulator (LDO) configured to generate a stable DC voltage based on the DC voltage generated by the rectifier;
a frequency divider circuit configured to divide the frequency of received RF signal; and
a Tx antenna configured to output the RF localization signal at the divided frequency to the external Rx antenna.

2. The system of claim 1, wherein the rectifier is a passive four-stage full-wave CMOS rectifier.

3. The system of claim 1, wherein the rectifier has a cross-coupled topology.

4. The system of claim 1, wherein the rectifier further comprises a plurality of deep n-well transistors.

5. The system of claim 1, wherein each stage of the rectifier further comprises coupling capacitors coupled to the signal to the input of the rectifier.

6. The system of claim 1, wherein the localizer further comprises an on-chip storage capacitor configured to reduce the ripple at the output of the rectifier.

7. The system of claim 1, wherein the LDO further comprises a smoothing capacitor.

8. The system of claim 7, wherein the LDO further comprises a compensation capacitor of a capacitance that is dependent upon the capacitance of the smoothing capacitor.

9. The system of claim 1, wherein the frequency divider circuit is a divide-by-3 circuit.

10. The system of claim 9, wherein the divide-by-3 circuit further comprises a mod-3 counter and an additional flip-flop.

11. The system of claim 1, wherein the RF power transfer signal has a frequency of 40.68 Mhz, and the RF localization signal has a frequency of 13.56 Mhz.

12. The system of claim 1, further comprising a controller, further comprising:
a memory; and
a processor configured by the memory to determine the position of the localizer by identifying a maximum localization signal power.

13. The system of claim 1, wherein the power of the RF localization signal is used to power a sensor electrically coupled to the localizer.

14. The system of claim 12, wherein the RF localization signal is modulated to encode data from a sensor decodable by the controller.

15. The system of claim 1, wherein the phase of the RF localization signal is synchronized to the phase of the RF power transfer signal.

16. The system of claim 1, wherein the phase of the RF localization signal is used to determine the position of the localizer.

17. The system of claim 1, wherein the amplitude of the RF localization signal is used to determine the position of the localizer.

18. A method for monitoring localization and physiological movements using a wirelessly powered localizer, the method comprising:
transmitting an RF power transfer signal using a Tx antenna of a controller;
receiving the RF power transfer signal at an Rx coil of a localizer;
rectifying the received RF power transfer signal to generate a DC voltage;
generating a stable DC voltage based on the generated DC voltage;
dividing the received RF signal to generate an RF localization signal;
transmitting the RF localization signal to an Rx antenna of a controller;
receiving the RF localization signal at the Rx antenna of the controller; and
determining the location of the localizer.

19. The method of claim 18, wherein the power of the RF localization signal is used to power a sensor electrically coupled to the localizer.

20. The method of claim 18, wherein the RF localization signal is modulated to encode data from a sensor decodable by the controller.
